(19) United States
(12) Patent Application Publication
(10) Pub. No.: US 2008/0088771 A1
(43) Pub. Date: Apr. 17, 2008

(54) Backlight module with lamp reflector means and liquid crystal display having same

(75) Inventor: Wei-Hao Hung, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/974,759

(22) Filed: Oct. 16, 2007

(30) Foreign Application Priority Data
Oct. 16, 2006 (TW) 95138079

(51) Int. Cl. G02F 1/1335; F21V 7/04

(52) U.S. Cl. 349/65; 362/621

(57) ABSTRACT

An exemplary backlight module (23) includes a frame (25), a light guide plate (26), a reflective film (290), and a lamp (27). The frame includes a side wall (252). The light guide plate includes a light incident surface (261) and a bottom surface (263) adjacent to the light incident surface. The reflective film is disposed adjacent to the bottom surface. The lamp is received in an accommodating space cooperatively defined by the light incident surface, an inner surface of the side wall, and the reflective film.

### FIELD OF THE INVENTION

The present invention relates to backlight modules such as those used in liquid crystal displays (LCDs), and particularly to a backlight module configured to efficiently utilize light beams from a light source without the need for a lamp reflector.

### GENERAL BACKGROUND

LCDs are commonly used as displays for compact electronic apparatuses. This is because they not only provide good quality images with little power consumption, but they are also very thin. The liquid crystal in a liquid crystal display does not emit any light itself. The liquid crystal has to be lit by a light source so as to clearly and sharply display text and images. Thus, a backlight module is generally needed for a liquid crystal display.

Referring to FIG. 4, a typical LCD 100 includes a top bezel 11, an LCD panel 12, a backlight module 13, and a bottom tray 14. The backlight module 13 provides a planar light source to illuminate the LCD panel 12. The top bezel 11 and the bottom tray 14 are fastened together to accommodate the LCD panel 12 and the backlight module 13 therebetween.

The bottom tray 14 includes a bottom board 141, a first side board 142, and a second side board 143. The bottom board 141 is rectangular, and the two side boards 142, 143 extend vertically up from opposite sides of the bottom board 141 respectively. The bottom board 141 includes two first through holes 144 disposed in two corners thereof and adjacent to two ends of the first side board 142, respectively.

The backlight module 13 includes a frame 15, a set of optical films 180, a light guide plate (LGP) 16, a lamp 17, a lamp reflector 18, two rubber pieces 19, and a reflective film 190. The LGP 16 has a rectangular shape, and includes a side light incident surface 161, a top light emitting surface 162 adjoining the light incident surface 161, and a bottom surface 163. The lamp reflector 18 includes two second through holes 184 corresponding to the two first through holes 144 of the bottom tray 14, respectively.

The two rubber pieces 19 grip two ends of the lamp 17 respectively, and the lamp reflector 18 receives the lamp 17 and the two rubber pieces 19. The lamp reflector 18 is disposed between the light incident surface 161 of the LGP 16 and the first side board 142 of the bottom tray 14. The reflective film 190 is disposed adjacent to the bottom surface 163 of the LGP 16, and the set of optical films 180 is disposed adjacent to the light emitting surface 162 of the LGP 16. The frame 15 receives the set of optical films 180, the LGP 16, the reflective film 190, and the lamp reflector 18. Two screws 194 are inserted in the two first through holes 144 and the two second through holes 184, such that the lamp reflector 18 is fastened to the bottom tray 14.

In operation, when light beams are emitted from the lamp 17, some of the light beams are directly introduced into the LGP 16 via the light emitting surface 161. The light beams pass through the LGP 16 and the set of optical films 180, and finally reach the LCD panel 12. Other of the light beams are reflected by the lamp reflector 18, and then are introduced into the LGP 16 via the light emitting surface 161. The light beams pass through the LGP 16 and the set of optical films 180, and finally reach the LCD panel 12. That is, the backlight module 13 effectively changes the linear light source (i.e. the lamp 17) into a surface light source, for evenly illuminating a whole display screen (not labeled) of the LCD panel 12.

The backlight module 13 needs the two second through holes 184 of the lamp reflector 18, the two first through holes 144 of the bottom tray 14, and the two screws 194 to fasten the lamp reflector 184 to the bottom tray 14. Thus the procedure of assembling the backlight module 23 is somewhat complicated and inconvenient.

What is needed, therefore, is a backlight module and an LCD having the backlight module which can overcome the above-described deficiencies.

### SUMMARY

A backlight module includes a frame, a light guide plate, a reflective film, and a lamp. The frame includes a side wall. The light guide plate includes a light incident surface and a bottom surface adjacent to the light incident surface. The reflective film is disposed adjacent to the bottom surface. The lamp is received in an accommodating space cooperatively defined by the light incident surface, an inner surface of the side wall, and the reflective film.

A liquid crystal display includes an LCD panel and a backlight module disposed adjacent to the LCD panel. The backlight module includes a frame, a light guide plate, and a lamp. The frame includes a side wall. The light guide plate includes a light incident surface. The lamp is positioned between the light incident surface and an inner surface of the side wall, the inner surface reflects received light beams generally toward the light incident surface, and the light guide plate redirects received light beams to the liquid crystal display panel.

Other aspects, novel features and advantages will become more apparent from the following detailed description when taken in conjunction with the accompanying drawings.

### BRIEF DESCRIPTION OF THE DRAWINGS

FIG. 1 is an exploded, isometric view of an LCD according to a preferred embodiment of the present invention, the LCD including a backlight module.

FIG. 2 is an assembled view of the backlight module of FIG. 1.

FIG. 3 is an enlarged, cross-sectional view taken along line III-III of FIG. 2.

FIG. 4 is an exploded, isometric view of a conventional LCD.

### DETAILED DESCRIPTION OF PREFERRED EMBODIMENTS

Reference will now be made to the drawings to describe preferred and exemplary embodiments in detail.

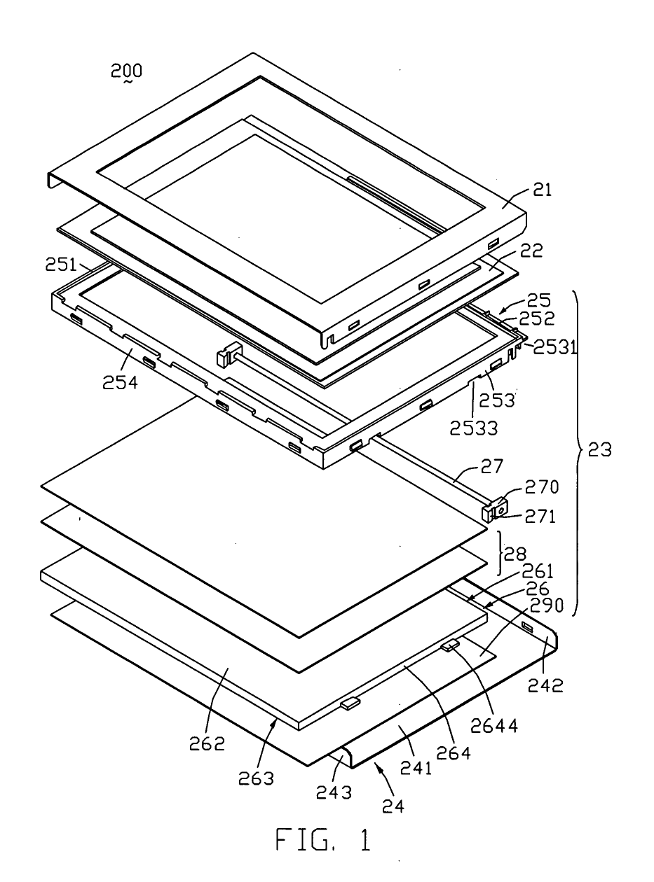

Referring to FIG. 1, an LCD according to a preferred embodiment of the present invention is shown. The LCD 200 includes a top bezel 21, an LCD panel 22, a backlight module 23, and a bottom tray 24. The backlight module 23 provides a planar light source to illuminate the LCD panel 22. The top bezel 21 and the bottom tray 24 are fastened together to accommodate the LCD panel 22 and the backlight module 23 therebetween.

The bottom tray 24 includes a bottom board 241, a first side board 242, and a second side board 243. The bottom board 241 is rectangular, and the two side boards 242, 243 extend vertically up from two sides of the bottom board 241 respectively.

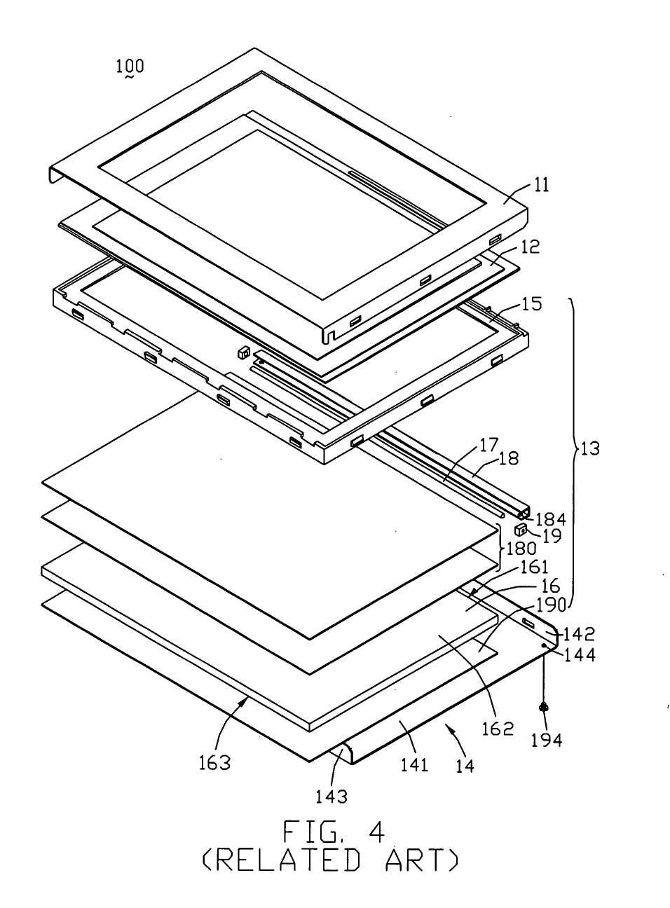

The backlight module 23 includes a frame 25, a set of optical films 28, a light guide plate (LGP) 26, a lamp 27, two supporting members 270, and a reflective film 290. Each supporting member 270 includes an end portion 271, which includes a narrowed neck portion extending from a main body of the supporting member 270. A top side view of the end portion 271 defines a “T” shape. The frame 25 includes a first side wall 251, a second side wall 252, a third side wall 253, and a fourth side wall 254. The first, second, third, and fourth side walls 251, 252, 253, and 254 are arranged end-to-end. An inner surface of the second side wall 252 is arc-shaped (see FIG. 3). A corner where the second side wall 252 and the third side wall 253 meet defines a gap 2531 corresponding to one of the supporting members 270. A corner where the first side wall 251 and the second side wall 252 meet defines another gap 2531 (not visible) corresponding to the other supporting member 270. The third side wall 253 includes two rectangular openings 2533, and the first side wall 251 includes another two rectangular openings 2533 (not visible). The frame 25 is made of resin with a high reflective ratio. The inner surface of the second side wall 252 is coated with material having a high reflective ratio, for example, titanium dioxide (TiO₂).

The LGP 26 has a rectangular shape, and includes a side light incident surface 261, a top light emitting surface 262 adjoining the light incident surface 261, a bottom surface 263 adjoining the light incident surface 261, and two side surfaces 264 adjoining the light incident surface 261 and the light emitting surface 262 respectively. The two side surfaces 264 are at opposite sides of the LGP 26. Each side surface 264 includes two square protrusions 2644, corresponding to two respective rectangular openings 2533.

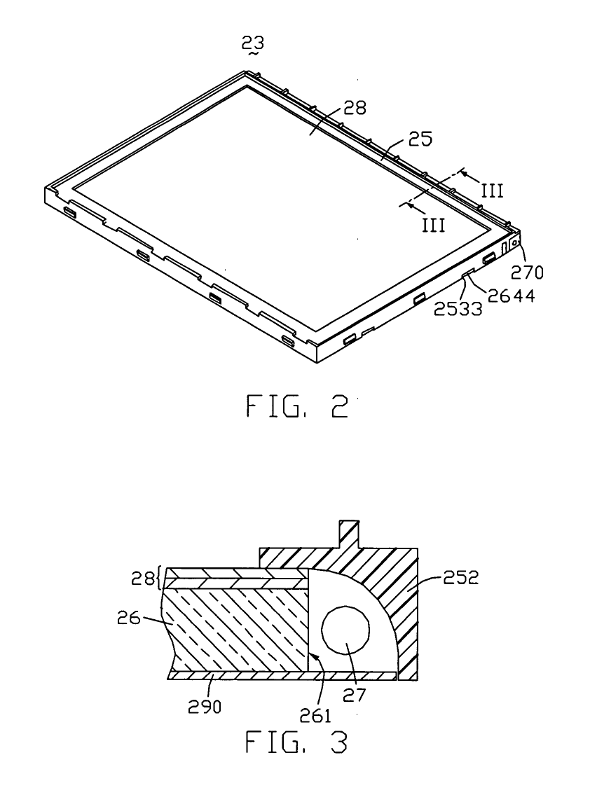

FIG. 2 is an assembled view of the backlight module 23. The two gaps 2531 of the second side wall 252 receive the two supporting members 270 respectively. Referring also to FIG. 3, the reflective film 290 is disposed adjacent to the bottom surface 263 of the LGP 26, and the set of optical films 280 is disposed adjacent to the light emitting surface 262 of the LGP 26. The lamp 27 is received in an accommodating space cooperatively defined by the light incident surface 261 of the LGP 26, the second side wall 252, and the reflective film 290. In the illustrated embodiment, the light incident surface 261 of the LGP 26, the second side wall 252, and the reflective film 290 enclose the lamp 27. The four rectangular openings 2533 of the frame 25 receive the four square protrusions 2644 of the LGP 26, such that the LGP 26 is fixed to the frame 25. Thus the frame 25 receives the set of optical films 28, the LGP 26, and the reflective film 290.

In operation, when light beams are emitted from the lamp 27, some of the light beams are directly introduced into the light incident surface 261 of the LGP 26. The light beams pass through the LGP 26 and the set of optical films 28, and finally reach the LCD panel 22. Other of the light beams are reflected by either or both of the inner surface of the second side wall 252 and the reflective film 290, and then are introduced into the LGP 26 via the light incident surface 261 of the LGP 26. The light beams pass through the LGP 26 and the set of optical films 28, and finally reach the LCD panel 22. That is, the backlight module 23 effectively changes the linear light source (i.e. the lamp 27) into a surface light source, for evenly illuminating a whole display screen (not labeled) of the LCD panel 22.

Unlike with the above-described conventional backlight module 13, the backlight module 23 does not need a lamp reflector 18. Thus the process of assembling the backlight module 23 is simple, and the cost of the backlight module 23 is reduced.

In an alternative embodiment, the reflective film 290 can instead be a reflective sheet or a reflective plate.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module, comprising:
a frame comprising a side wall;
a light guide plate comprising a light incident surface and a bottom surface adjacent to the light incident surface;
a reflective film disposed adjacent to the bottom surface; and
a lamp;
wherein the lamp is received in an accommodating space cooperatively defined by the light incident surface, an inner surface of the side wall, and the reflective film.

2. The backlight module as claimed in claim 1, wherein the inner surface of the side wall is circular arc shape.

3. The backlight module as claimed in claim 1, wherein the frame is made of resin with high reflective ratio.

4. The backlight module as claimed in claim 1, wherein the inner surface of the side wall is galvanized with high reflective ratio material.

5. The backlight module as claimed in claim 4, wherein the inner surface of the side wall is galvanized with titanium dioxide.

6. The backlight module as claimed in claim 1, wherein the side wall comprises two gaps disposed at two terminals of the side wall.

7. The backlight module as claimed in claim 6, further comprising two supporting members receiving two terminals of the lamp respectively, wherein the two gaps of the side wall receive the two supporting members respectively.

8. The backlight module as claimed in claim 7, wherein each supporting member comprises a end portion.

9. The backlight module as claimed in claim 8, wherein a top view of the end portion is “T” shaped.

10. The backlight module as claimed in claim 1, wherein the frame further comprises a second side wall and a third side wall adjoining the side wall of the frame respectively.

11. The backlight module as claimed in claim 10, wherein the second and third side walls comprise two rectangular openings respectively.

12. The backlight module as claimed in claim 11, wherein the light guide plate further comprises two side surfaces adjoining the light incident surface respectively.

13. The backlight module as claimed in claim 12, wherein each side surface of the light guide plate comprises two square protrusions corresponding to the two rectangular openings respectively.

14. A liquid crystal display, comprising:
a liquid crystal display panel; and
a backlight module disposed adjacent to the liquid crystal display panel, the backlight module comprising:
a lamp emitting light beams;
a frame comprising a side wall; and
a light guide plate comprising a light incident surface;
wherein the lamp is positioned between the light incident surface and an inner surface of the side wall, the inner surface reflects received light beams generally toward the light incident surface, and the light guide plate redirects received light beams to the liquid crystal display panel.

15. The liquid crystal display as claimed in claim 14, wherein the frame is made of resin with high reflective ratio.

16. The liquid crystal display as claimed in claim 14, wherein the inner surface of the side wall is galvanized with high reflective ratio material.

17. The liquid crystal display as claimed in claim 17, wherein the inner surface of the side wall is galvanized with titanium dioxide.

18. The liquid crystal display as claimed in claim 14, further comprising a reflective film, wherein the light guide plate further comprises a bottom surface, the reflective film is disposed adjacent to the bottom surface and the inner surface of the side wall, and a portion of the reflective film between the light incident surface of the light guide plate and the inner surface of the side wall reflects received light beams generally toward the light incident surface.
